(19) United States
(12) Patent Application Publication
(10) Pub. No.: US 2005/0010685 A1
(43) Pub. Date: Jan. 13, 2005

(54) Method and a system for enabling data to be stored in a computer network; a method and a system for storing data in a computer network

(75) Inventors: Vasudha Ramnath, Singapore (SG); Lek Heng Ngoh, Singapore (SG)

Correspondence Address: CROCKETT & CROCKETT, 24012 CALLE DE LA PLATA, SUITE 400, LAGUNA HILLS, CA, 92653, US

(73) Assignee: Agency For Science, Technology and Research

(21) Appl. No.: 10/618,190

(22) Filed: Jul. 11, 2003

(51) Int. Cl. G06F 15/173

(52) U.S. Cl. 709/238; 370/351

(57) ABSTRACT

A method for enabling storage of data in a computer network comprising a plurality of computer nodes, wherein each computer node comprises at least one connection oriented link layer unit, the method comprising the steps of defining a looping path in the computer network, wherein the looping path comprises a plurality of computer nodes and connections between the computer nodes and configuring a connection unit at each node along the looping path, the connection unit being supported by the connection oriented link layer unit, such that the connection oriented link layer unit at each computer node is able to send incoming data which is to be stored in the computer network to a next computer node along the looping path based on the connection unit, thereby providing the looping path for data to be circulated therein, and thereby enabling the storage of data in the computer network.

This invention relates to a method and a system for enabling data to be stored in a computer network, and also a method and a system for storing data in the computer network.

### BACKGROUND OF THE INVENTION

A computer network is normally used as a transport mechanism whereby data are transmitted from one node to another through physical network interconnecting the nodes. The computer network usually comprises a plurality of computer nodes which are implemented using computers, routers, network hubs, etc. These computer nodes are connected to one another, enabling data to be transferred from one node to another. The transmission of the data in the network is controlled using network protocols implemented on the computer nodes supporting a routing and a signaling framework.

The routing framework which can be implemented by running routing protocols, such as Open Shortest-Path-First (OSPF) or Intermediate-Systems to Intermediate-System (IS-IS) as disclosed in [1] and [2], provides information on the topology and resource availability of the nodes. The signaling framework which can be implemented by running signaling protocols, such as Label-Distributed Protocol (LDP) or Resource Reservation Protocol (RSVP) as disclosed in [3] and [4], establishes the forwarding path of the data based on the information obtained from the routing framework.

Multi-Protocol Label Switching (MPLS) (see [5] and [6]) has been used as a control plane on computer nodes to control the forwarding of the data along the forwarding paths established in the network based on the routing and signaling protocols. Normally, data is forwarded in the form of data packets based on the content of the data packet headers. The data packets are partitioned into sets of Forwarding Equivalence Classes (FECs), and each FEC is mapped to a next hop (node) in the network along the established paths.

In MPLS, the FEC assigned to each data packet is encoded as a short fixed length value known as “label” and is forwarded together with the data packet to the next hop. At subsequent hops, the label is used as an index into a table at each node to find the next hop. The label is replaced with a new label and the data packet is forwarded to another next hop based on the new label. In MPLS, the path taken by the data packet through a series of nodes to a destination node is known as the Label Switched Path (LSP).

Attempts have been made by many researchers to persist/store data in computer networks. However, such attempts to store data in the computer network are only implemented by storing the data in the computing nodes themselves or in a memory unit of a computer connected to a node in the network. When a large number of nodes want to read the data which is stored in the computer nodes, a number of point-to-point connections need to be established to deliver the requested data from these computer nodes to the nodes requesting such data. However, this causes congestion in the network, and hence renders the process inefficient.

CANARIE Inc. has developed a concept of Wavelength Disk Drives (WDD) for storing data in a wide scale multi-wavelength Dense Wave Division Multiplexing (DWDM) system as disclosed in [7]. The purpose of the WDD is to allow a single application to harness the computing power of processors in different computers which are connected in a network. However, the WDD is implemented on the transport or application layer of the computer network. This means the processing overheads at every node is high, as additional headers need to be processed for each packet. Also, CANARIE's scheme does not allow the network resources to be partitioned easily for storage and transport. This results in poor bandwidth resource allocation in the WDD network, and hence, its use as a storage system will affect the normal data transportation function.

Thus, it is desirable to be able to store data in a computer network in such a way that the available network resources are utilized efficiently.

### SUMMARY OF THE INVENTION

The invention is provided with a method for enabling data to be stored in a network comprising a plurality of computer nodes according to the features of the independent claims. Preferred embodiments of the invention are defined in the dependent claims.

The method according to the invention is implemented in a computer network comprising a plurality of computer nodes, wherein each computer node comprises at least one connection oriented link layer unit. The method for enabling the storage of data in the network comprises the step of defining a looping path in the computer network, wherein the looping path comprises a plurality of computer nodes and connections between the computer nodes, and configuring a connection unit at each node along the looping path, the connection unit being supported by the connection oriented link layer unit, such that the connection oriented link layer unit at each computer node is able to send incoming data which is to be stored in the computer network to a next computer node along the looping path based on the connection unit, thereby providing the looping path for data to be circulated in, and thereby enabling the storage of data in the computer network.

According to the invention, a connection oriented link layer (COLL) unit is used for controlling the forwarding of data at each computer node of the computer network. The COLL unit is a connection oriented service implemented at the data forwarding plane, which is between layers 1 and 3 of the OSI model on each of the computer nodes of the computer network. The COLL unit sends data from a source node by establishing a connection with the COLL unit of the destination node and setting up a virtual path, wherein data are sent to the destination node using this virtual path.

The setting up of the looping path in the computer network for data storage involves a first step of using the COLL unit to define the path wherein data is to be stored. The path comprises a series of computer nodes wherein the first node along the path is also the last node of the same path, so that data are made to loop in the path, and hence can be stored in it.

Each computer node comprises a configurable connection unit which specifies how incoming data arriving at the computer node is to be handled. According to a second step of the invention, the connection unit at each computer node along the defined looping path is configured such that incoming data arriving at the computer node from a previous node along the looping path is switched out to the next node along the looping path.

The switching of data at each computer node is performed by the COLL unit, onto which the connection unit is supported. Specifically, the COLL unit at each computer node receives the incoming data, and based on the configuration of the connection unit, switches them as outgoing data to the next computer node specified by the connection unit. Therefore, data can be stored in the computer network by being circulated in the looping path.

The method according to the invention allows wide-area storage devices like giant-sized disks or shared memory for Inter-Processor Communications to be implemented. The data stored in the network can thus be utilized by applications or computers connected to the computer nodes which may be thousands of kilometers apart.

The storing of data in looping paths in the computer network according to the invention also allows fast access of the stored data by the computers or applications at the computer nodes. This is because applications at computer nodes can read data directly from the network instead of reading the data from another computer or memory unit attached to another computer node, thus eliminating the slow point-to-point communication between the computer nodes.

Also, since the method according to the invention creates an entity in the control plane of the computer network called a switched path wherein the switched path is uniquely identified and can be easily managed by protocols of the control plane, this switched path is easily configurable in terms of bandwidth resources. Hence, the network can be partitioned in terms of resources for storing data in the looping path, and for normal transportation of data in other parts of the same network. For example, an administrator is able to reserve some bandwidth in the network for the looping path. When demand for normal transportation in the computer network is high, the amount of bandwidth reserved for the looping path can be changed accordingly. In addition, a high priority level may also be set for the looping path that allows the looping path to be kept intact even in the event that the demand for normal transportation of data is high. On the other hand, priority for the looping path can be lowered to allow normal transportation of data to have additional bandwidth.

It should be noted that the method according to the invention can be implemented on computer nodes of the computer network using existing network protocols, and does not require any specialized hardware. The method according to the invention is also not restricted to any network topologies, and can be implemented onto the nodes of the computer network having a ring topology, a mesh topology or star-shaped topology.

The COLL unit may be implemented using any protocols which support connection oriented services (see [8]) like Asynchronous Transfer Mode (ATM), Frame-Relay, Multi-protocol Label Switching (MPLS), etc.

According to a preferred embodiment of the invention, the COLL unit is implemented according to a generalized MPLS specification. The generalized MPLS supports not only the switching of data packets at each computer node, but also supports lambda switching, fiber switching and time-division multiplexing in a computer network which connects the computer nodes using optical fibers. In other words, the COLL unit (or the control plane) based on the generalized MPLS implemented on each computer nodes does not only make forwarding or switching decisions of data based on the label of each incoming data packet, but can also make such decisions based on wavelengths, physical ports or time slots.

In a preferred embodiment of the invention, the COLL unit at each computer node supports a signaling framework, which framework is implemented by running a signaling protocol on the nodes. In this embodiment, the signaling protocol running on the nodes may be implemented using the Label Distribution Protocol (LDP) or Resource Reservation Protocol (RSVP). The signaling protocol is also preferably used to configure the connection unit at each node of the defined looping path to set up the looping path.

Therefore, the setting up of the looping path can be performed automatically using the signaling protocol implemented on each computer node without requiring the administrator to configure each connection unit at every node of the looping path, using node-specific or other types of programmatic interfaces. This automatic setting up of the looping path using signaling protocol can save a lot of time and effort for the network administrator, especially when the looping path comprises many nodes.

In this preferred embodiment of the invention, the connection unit at each node along the looping path is configured by a signaling message generated by the signaling protocol running on each of the nodes of the looping path. The signaling message contains essential information for setting the essential attributes in the connection unit in order to set up the defined looping path.

According to the invention, an attribute of the connection unit at each computer node is set to a predefined value, so that the looping path can be identified and differentiated from a normal path by testing the value of the said attribute. This allows the COLL unit to process data in the looping path differently from normal data.

The attribute of the connection unit may be set by the administrator through a programmatic interface at each computer node along the looping path in an alternative embodiment. However in the preferred embodiment of the invention, the attribute of the connection unit is set by the signaling message from the signaling protocol running on the computer nodes. The advantage of setting the attribute of the connection unit by the signaling message is that the attribute of the connection unit at each node of the looping path can be set automatically without having to configure each node manually by the administrator as mentioned above.

The method for enabling the storage of data in the computer network further comprises the steps of identifying the looping path based on an attribute of the signaling message, and preventing the identified looping path from being aborted by the signaling protocol running on the computer nodes of the computer network.

This attribute of the signaling message is used to identify the looping path by setting the said attribute to a predefined value. The said attribute of the signaling message when sent to a computer node in the looping path is read by the COLL unit of the node, which then updates the attribute in the connection unit to identify the path signaled by the signaling message as a looping path.

Looping paths are normally undesirable in the computer network as they consume valuable bandwidth in the network. Therefore, most signaling protocols running on the computer nodes have mechanisms to detect looping paths and abort them. Thus the invention also further ensures that the creation process of the looping path is not aborted by the loop detection mechanisms of the signaling protocol, so that data can be stored or circulated in the created looping path for a configurable amount of time. However for normal data which is not intended to be stored in the looping path, the loop detection mechanisms are still needed to detect if the paths for these normal data are looping, and abort them accordingly.

In a preferred embodiment of the invention, a further attribute of the signaling message having a value which is being incremented at each computer node along the looping path is set to a predefined value at at least a predefined computer node along the path of the looping path.

Signaling messages from signaling protocols, such as LDP, has a further attribute with a value which is being incremented at every node along the looping path. This further attribute is normally used by the signaling protocols to detect looping paths. When the value of this further attribute exceeds a threshold value, the path to be set up by the signaling protocol is deemed to be looping, and the process of setting up the path defined in the signaling message is aborted. Thus by setting the value of this attribute to a predefined value, the value of this further attribute will not exceed the threshold value, and hence the setting up of the looping path will not be aborted by the signaling protocol.

In another preferred embodiment of the invention, another further attribute of the signaling message having a node identifier of each computer node being added to it at the respective computer node of the looping path is set to a predefined value at at least a predefined node along the looping path.

Signaling messages from signaling protocols, such as LDP or RSVP, also have an attribute with a value which is the result of the node identifier of each node along the looping path being appended to it. When the length of this attribute becomes too long such that it exceeds a threshold length, the signaling protocol interprets that the path is looping, and hence, aborts the setting up of the said path by the signaling protocol. Thus by setting the value of this other further attribute to the predefined value according to the invention, the length of the attribute will not exceed the threshold length, and hence, will not be aborted by the signaling protocol.

According to another aspect of the invention, a method for storing data in a computer network comprising a plurality of nodes is provided, wherein each node comprises at least one connection oriented link layer unit, the method comprising the steps of identifying a looping path in the computer network comprising a plurality of computer nodes by the connection oriented link layer unit, and injecting data into the identified looping path at the computer node, in which looping path the injected data is to be circulated in, thereby storing the data in the computer network.

This aspect of the invention relates to storing data in a looping path created in the computer network. The looping path available for storing data is first identified by the COLL unit according to the invention. In this case, a further attribute in the connection unit at each node of the looping path may be used to contain a value which uniquely identifies a specific looping path from a plurality of looping paths for data storage.

When a specific looping path to be used for storing data is identified, data to be stored is then injected into the identified looping path by the COLL unit of the computer node.

The COLL unit according to a preferred embodiment of the invention is implemented according to a generalized MPLS specification. The advantages of using the generalized MPLS specification are already described above. It should also be noted again that it is possible to implement the COLL unit according to other protocols such as ATM or Frame-relay.

The injection of data in the identified looping path according to the invention further comprises the steps of affixing a header, in particular a network header, to each data packet of the data to be injected into the looping path at a computer node, wherein the header is associated with the identified looping path, determining the forwarding path information of the header affixed to the data packet by the COLL unit at the computer node, and affixing a further COLL header by the COLL unit to the data packet affixed with the network header at the computer node, wherein the COLL header comprises an outgoing label which maps the data packet into the identified looping path, thereby storing the data in the computer network. The network header which is affixed to the data packet is preferably a network-layer header. As the network-layer header contains information relating to the identification of the looping path, such information is used to differentiate data packets to be stored in the looping path according to the invention from the normal data packets to be transported through the computer network.

Depending on the implementation of the COLL unit, the COLL header may comprise a time to live (TTL) field having a value which is being decremented by the COLL unit at each computer node. Such a TTL field has a maximum value when it is first injected into the looping path. When the value of the TTL field decreases at each computer node and falls below a threshold value, the data packet which the COLL header is affixed to is discarded as the path taken by the data packet is assumed to be looping.

In a preferred embodiment of the invention, the value of the TTL field is set to a predefined value by the COLL unit at at least one computer node along the looping path. In this way, the value of the TTL field never falls below the threshold value, and hence the data packet is able to continue to circulate in the looping path indefinitely, or for a configurable amount of time.

In the case of a typical transportation of a data packet in the computer network, the TTL field in the network header of the packet is initialized based on the TTL field of the COLL header when the packet exits the LSP. However, when a data packet exits the looping LSP from a DIN node, that DIN node behaves as the source node for that data packet, and sets the network layer TTL field to the maximum value to allow it to be transported to a destination node in the network.

It should be noted that this aspect of the preferred embodiment cannot be implemented using ATM protocols in the COLL unit as the COLL header in this case does not have any TTL field.

The invention further provides a method for removing data stored in the looping path of the computer network, wherein the method comprises setting an administrative bit in a signaling message generated by the signaling protocol running on the computer nodes to a predefined value, and sending the signaling message to a computer node along the looping path, thereby setting an administrative attribute of the connection unit at the computer node and causing the computer node to remove the data stored in the looping path of the computer network.

In this case, when the computer node receives the signaling message with the administrative bit set to the predefined value, the node updates the administrative attribute of its connection unit associated with the looping path. This causes any incoming data arriving at the computer node from that looping path to be removed, until the administrative attribute of the connection unit is updated again.

It should be noted that the setting of the administrative attribute of the connection unit for removing data stored in the looping may be achieved through a programmatic interface provided at the computer node instead of using signaling messages.

The invention also further provides a method for reading data stored in the looping path of the computer network, the method comprises sending an experimental message generated by the signaling protocol running on the computer nodes of the computer network to a computer node along the looping path, thereby setting a duplicate attribute of the connection unit at that computer node and causing the computer node to duplicate the data stored in the looping path of the computer network.

The method described in this case allows data stored in the looping path of the computer network to be read by a computer node. Since data in the looping path has no final destination but circulates in the looping path, a computer node which wants to read the stored data has to duplicate the data into a buffer, and also has to forward the data to the next node along the looping path to let it continue to circulate in the looping path.

An experimental message generated by the signaling protocol is sent to the computer node where duplication is to be performed. The computer node on receiving the experimental message sets the duplicate attribute of its connection unit associated with the looping path, so that any incoming data from the looping path arriving at the computer node are duplicated. In addition, a further attribute may be attached to the duplicate attribute of the connection unit associated with the looping path, so that duplicated data may be delivered using normal data transport paths to the application requesting the data

It should again be noted that the setting of the duplicate attribute of the connection unit for duplicating data stored in the looping path may be achieved through a programmatic interface provided at the computer node instead of using signaling messages.

The invention also provides a system for enabling storage of data in a computer network comprising a plurality of computer nodes, wherein each computer node comprises at least one connection oriented link layer unit, the system comprising a definition unit for defining a looping path in the computer network, wherein the looping path comprises a plurality of computer nodes and connections between the computer nodes, and a configuration unit for configuring a connection unit at each node along the looping path, the connection unit being supported by the connection oriented link layer unit, such that the connection oriented link layer unit at each computer node is able to send incoming data which is to be stored in the computer network to a next computer node along the looping path based on the connection unit, thereby providing the looping path for data to be circulated in, and thereby enabling the storage of data in the computer network.

In a preferred embodiment of the invention, optical fibers are used as the connections between the computer nodes in the computer network. The advent of Dense Wavelength Division Multiplexing (DWDM) technique has caused the bandwidth of optical fibers to increase tremendously, reaching a current capacity of about 1.6 Terabits per second. Each optical fiber is able to carry multiple wavelengths which can be processed individually by computer nodes, in particular photonic nodes. Therefore, at least one wavelength can be used to create loops for storing data without significantly affecting the overall bandwidth of the computer network comprising optical fibers.

Another advantage of using optical fibers is that data in the fibers travels at about 0.66 times the speed of light. Therefore, data which is stored in the looping path contained in optical fibers according to the invention can be delivered to nodes requesting them almost instantaneously even when the nodes are thousands of kilometers away.

It should however be noted that the connections between the computer nodes are not limited to optical fibers, but may also be implemented using other connection means, for example, Ethernet cables, Radio Frequency connections, etc.

A system according to the invention is also provided for storing data in a computer network comprising a plurality of computer nodes, wherein each computer node comprises at least one connection oriented link layer unit, the system comprises an identification unit for identifying a looping path in the computer network comprising a plurality of computer nodes by the connection oriented link layer unit of a computer node; and an injection unit for injecting data into the identified looping path at the computer node, in which looping path the injected data is to be circulated in, thereby storing the data in the computer network.

The system further comprises a removal unit at at least one computer node for removing the data stored in the identified looping path when an administrative attribute of a connection unit at the computer node is set, thereby causing the computer node to remove the data stored in the looping path.

The system also further comprises a retrieval unit at at least one computer node for duplicating the data stored in the identified looping path when a duplicate attribute of the connection unit at the computer node is set, thereby causing the computer node to retrieve the data stored in the looping path. It should be noted that the retrieval unit allows the data stored in the looping path to be read at the computer node without removing the data from the looping path. The retrieved data can further be delivered to another computer node requesting the data.

### BRIEF DESCRIPTION OF THE FIGURES

FIG. 1 shows how data packets are transmitted inside an optical fiber.

FIG. 2 shows an implementation of a created looping path on a computer network according to the invention.

FIG. 3 shows the Explicit Route (ER) TLV of the Label Request/Mapping Message of the LDP signaling protocol.

FIG. 4 shows the Explicit Route Hop (ER HOP) TLV of the Label Request/Mapping Message of the LDP signaling protocol.

FIG. 5 shows the Looping LSP TLV of the Label Request/Mapping Message of the LDP signaling protocol.

FIG. 6 shows how data packets are sent to the looping path created according to the invention.

FIG. 7 shows the Admin Status TLV of the Label Request/Mapping Message of the LDP signaling protocol.

FIG. 8 shows the Action Message of the LDP signaling protocol.

FIG. 9 shows the LSP ID TLV of the Action Message.

### DETAILED DESCRIPTION OF PREFERRED EMBODIMENTS OF THE INVENTION

A computer network in very general term comprises a plurality of computers which are linked together to allow exchange of information among them.

A Local Area Network (LAN) is a group of computers which are connected together in a localized area. It generally comprises personal computers, printers, servers and other devices and allows sharing of resources by devices connected to the LAN.

A Wide Area Network (WAN) covers a large geographical area and often uses physical transmission lines like optical fiber, telephone lines, etc. Service Providers (SP) may allow one or more LANs to be connected to the WAN using routers, giving rise to the computer network allowing transportation of data from one computer to another.

The computer network in this case comprises routers at the interface between the LAN and WAN, computers in the LAN, switches in the WAN, hubs, servers or any programmable devices. These devices at various junctions of the computer network are known as computer nodes.

The Open System Interconnection (OSI) reference model developed by the International Organization for Standardization (ISO) describes how information is transmitted from one computer node to another computer node through the physical network connections. The OSI model is now the standard communication architecture model for a computer node of a computer network, and is described briefly here. The detailed description of the OSI reference model is easily available in networking literature.

The OSI model has seven layers (known as OSI layers) Layer 1 to Layer 7. Layer 1 is the physical layer which is concerned with transmitting raw data bits over a communication channel. Layer 2 is the data link layer which provides a reliable transmission of data across the physical layer. Layer 3 is the network layer which controls the operation of the network. Layer 4 is the transport layer which accepts data from the Layer 5 and segments it for the network layer (Layer 3) to be transmitted. Layer 5 is the session layer which manages communication sessions between computer nodes. Layer 6 is the presentation layer which is concerned with coding and conversion functions for the Layer 7 data. Layer 7 is the application layer which interacts directly with a user software/interface.

In this specification, we divide the OSI layers into two portions: the communication layers and the data forwarding layers. The communication layers is generally used to refer to user end application (layers 4 to 7). The data forwarding layers is generally used to refer to the transportation of data in the network (layers 1 to 3).

The use of optical fibers for data transmission between computer nodes in a computer network has gained popularity due to the large amount of information a single optical fiber can carry. The ability to transmit data simultaneously at different wavelength of light in a single strand of optical fiber, a concept known as Dense Wavelength Division Multiplexing (DWDM), further increases the bandwidth of the fiber. This makes optical fiber an ideal choice to cater for the large volume of data traffic in the computer network like the internet.

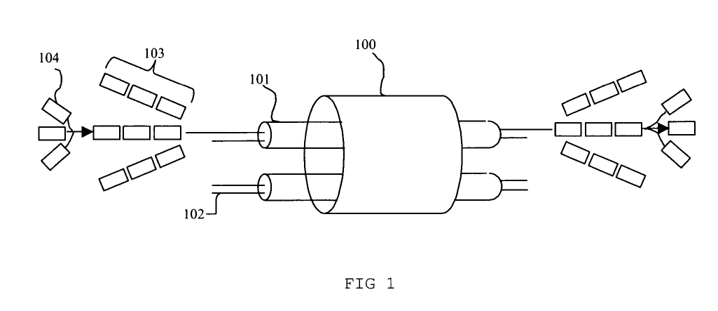

FIG. 1 shows an exploded view of a portion of an optical fiber bundle 100. The fiber bundle 100 comprises a plurality of optical fibers 101, wherein data are transmitted inside each of these optical fibers 101.

In a computer network, data packets 104 are multiplexed into data streams 103. The multiplexed data streams 103 are then transmitted in optical fibers 101, wherein each optical fiber 101 comprises a plurality of wavelengths 102 for transmitting several multiplexed data streams 103. The optical fibers 101 are bundled to form the optical fiber bundle 100 which is used to connect to other computer nodes which can be thousands of kilometers away.

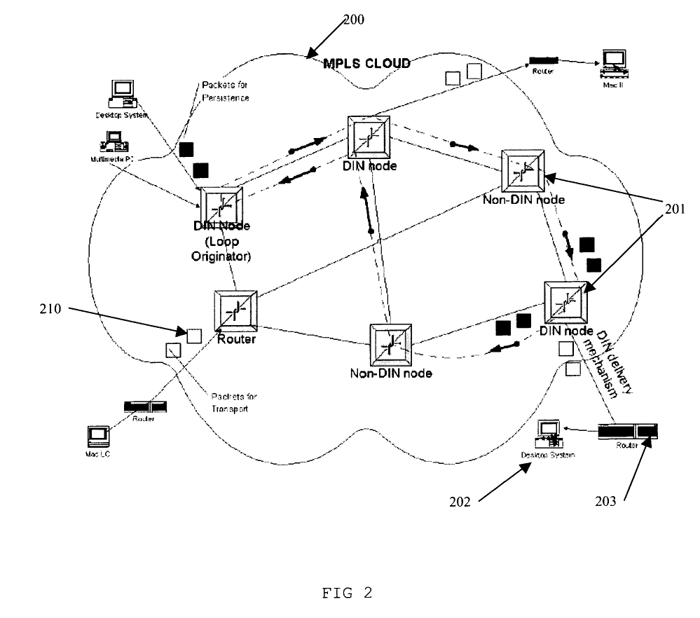

FIG. 2 shows a computer network 200 with possible looping paths created according to the invention. The computer network 200 comprises a plurality of computer nodes 201. Computers 202 are connected to the network or WAN 200 using routers 203.

Data packets 210 to be transmitted from a source computer 202 to a destination computer 202 are first injected into the network 200 through an ingress node 201. The data packets 210 are then transmitted to the destination computer along a path through the nodes 201. The transmitting of the data packets 210 in the network 200 is accomplished by forwarding each data packet 210 at each node 201 along a forwarding path. At each node 201, the content of the packet header is read and the data packet 210 is forwarded to a next node 201 based on the content of the packet header. The next node 201 also reads the content of the data packet header and determines a further next node for the data packet 210 to be forwarded to. The forwarding process continues until the data packet 210 is received by the destination computer 202.

The forwarding path in the computer network is set up by configuring a connection unit at each of the computer nodes along the forwarding path. Each computer node should preferably have a programmatic interface which allows the settings of the connection unit to be configured. The settings of the connection unit may be configured using software or by an administrator.

The connection unit comprises connection entities which may have, for example, the form of <port, logical identifier, direction>. The port defines the physical port on the computer node, at/from which data is received/sent, logical identifier is a locally-scoped identifier to identify a switched path, and the direction defines whether the connection entity is an incoming or an outgoing entity. Using the connection unit, a pair of connection entities on a computer node can be created such that an incoming connection from a previous node connects to an outgoing connection to a next node along a forwarding path.

By establishing a series of connection entities on a plurality of computer nodes, a looping path that begins and ends on the same computer node can be defined. For example, a path may begin at an initial node I. On this node I an outgoing connection entity <X, ID 30, OUT> is created. The path may end at an end node E such that it has an incoming connection entity <Y, ID 40, IN>. Nodes I and E need not be adjacent, but are connected by a switched path passing through none or at least one node at which the appropriate connection entities have been configured such that the switched path begins at Node I: <X, 30, OUT> and ends at Node E: <Y, 40, IN>. To establish a looping path between I and E, an outgoing connection entity on Node E and an incoming connection entity on Node I can be added such that <Y, ID 40, IN>on Node E is connected to <X, ID 30, OUT> on Node I.

The configuration of the connection unit, in particular the connection entities, is set by a signaling message generated by a signaling protocol running on each of the computer nodes of the computer network.

However, it should be noted that the configuration of the connection unit can also be set by the administrator at every node along the looping path in an alternative embodiment.

The path which is set up in the computer network is generally referred to as a Label Switched Path (LSP). With a looping LSP set up, any computers connected to the network, subject to the administrative permissions, are able to store and access data in this created looping path.

According to the invention, a method is provided for enabling data to be stored in a computer network by creating a looping path through a plurality of nodes, so that data packets can be made to loop in the created looping path instead of being transmitted to a destination node. In other words, data are said to “persist” in the network, and the created looping path is called the “persistent path” (the term “created looping path” and “persistent path” shall be used interchangeably henceforth).

The preferred embodiments of the invention will now be described in detail.

A connection oriented link layer unit, such as one based on generalized Multi-Protocol Label Switching (MPLS), is implemented on the computer nodes of the computer network to control the forwarding of the data packets 210. The MPLS based control plane comprises both a routing framework and a signaling framework and also supports significant applications such as constrained-based routing as described in [9]. The routing framework runs routing protocol such as Open Shortest Path First (OSPF) or Intermediate Systems (IS-IS) to obtain information on the topology and resources of the network. The signaling framework runs signaling protocols such as Label-Distributed Protocol (LDP) or Resource Reservation Protocol (RSVP) to establish the forwarding paths based on the information obtained from the routing protocol and other constraints imposed by an administrator.

In order for looping paths to be created and maintained in the network, modifications are made to the signaling protocols so that the created looping or persistent paths according to the invention can be differentiated from undesired looping paths, and only the persistent paths are prevented from being aborted by the signaling protocols. Furthermore, other parameter or persistent attributes of the persistent paths, like the bandwidth allocated for storing of data in the looping paths or the time for the stored data to circulate in the looping path, can be configured.

The invention is deployed on the network such as the one as shown in FIG. 2, but is not restricted to any topology (ring, mesh or star). The COLL unit implemented on the nodes 201 of the network 200 is preferably according to the generalized Multi-Protocol Label Switching (MPLS) specification. The nodes 201 may run additional protocols such as Link Management Protocol as described in [10] to comply with the generalized MPLS specification.

In addition, signaling protocols should preferably support Traffic Engineering described in [11] and routing protocol should preferably implement Traffic Engineering extension to routing as described in [12].

In the generalized MPLS network, data packets 210 are forwarded based on labels affixed to the packet headers instead of reading the content of the packet headers.

When the data packet 210 to be transmitted are sent to an ingress node, the content of each of the packet header is read and a label is affixed to the packet header. The data packet 210 and its packet header is then sent to a next node 201 of the forwarding path together with the label. The next node 201 reads the label affixed to the data packet 210 (not the content of the packet header) and forwards the data packet 210 to another node 201 along the forwarding path. Thus, the data packet 210 is said to be “switched” by the nodes, and the nodes are called “Packet Switching Capable” (PSC) nodes.

It should be noted that although the nodes 201 are described to switch data packets, it is also possible for the generalized MPLS based network 200 to support nodes that are capable of switching data based on TDM, wavelengths (lambda) and entire fibers. When switching based on TDM is desired, TDM-capable nodes should be implemented as the network nodes 201 instead of PSC nodes. Similarly, when switching based on wavelengths and entire fibers is desired, Lambda Switch Capable (LSC) nodes and Fiber Switch Capable (FSC) nodes should be implemented as the network nodes 201, respectively.

At least one node 201 in the network 200 is to function as a Data-in-Network (DIN) node. The DIN node is a “modified” node which is capable of creating and managing the persistence attribute of the persistent path and the data stored therein. The DIN node is hence also able to read certain attributes associated with the looping path, and to modify the attributes, if necessary. The DIN node, which normally serves as an ingress or egress node for data in the persistent path, co-exists with other non-DIN nodes in the network 200.

It should be noted that only one node along the persistent path is necessary to function as a DIN node, and the other nodes may be non-DIN nodes. However, for good performance and control processing of persistent paths that are very long, or have complex loops, a plurality of DIN nodes is preferably implemented in the network 200.

Creation and Management of the Persistent/Looping Path

The creation of the persistent path is initiated by a DIN node, known as the Loop Initiator, by generating a Label Request Message from a signaling protocol such as LDP. The Label Request Message is forwarded along a path wherein we desire to implement persistence, e.g. to store data therein.

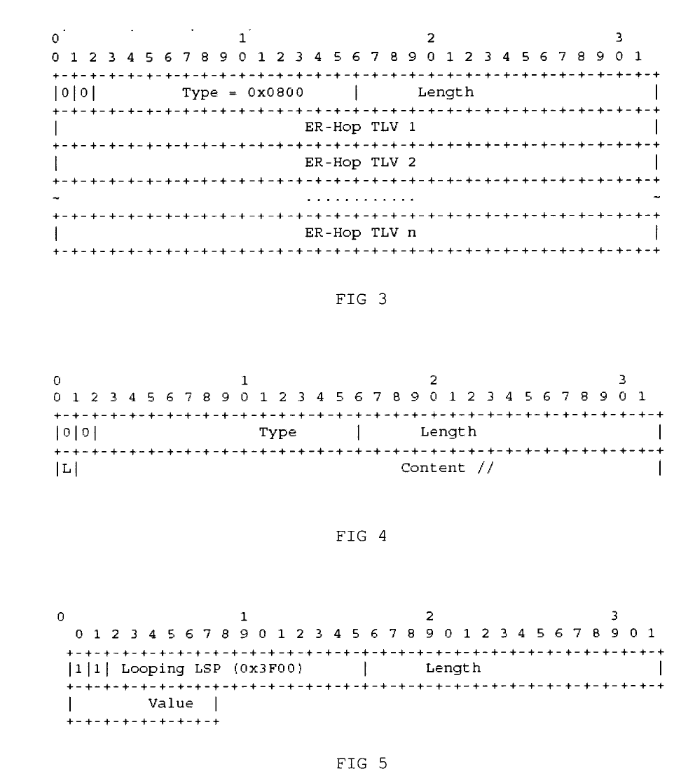

The path of the persistent path is defined in an Explicit Route attribute (ER TLV) of the Label Request Message. The ER TLV is an object that specifies the path of the persistent path and comprises one or more Explicit Route Hop TLVs (ER-HOP TLVs) as shown in FIG. 3.

Each computer node along the persistent path is assigned a unique Label-Switch-Router ID (LSR ID) which identifies each node in the network. The path of the persistent path is defined in the ER TLV by setting the value of each ER-HOP TLV to a corresponding LSR ID. The ER-HOP TLV is shown in FIG. 4.

The path is defined such that it starts and ends at the same node, preferably at the Loop Initiator. This is achieved by setting the value of the last ER-HOP TLV of the ER TLV as the LSR ID of the Loop Initiator. However, in another embodiment, the Loop Initiator may activate some other DIN nodes to cause a looping LSP to be setup, and the Loop Initiator may not lie in the path of this LSP. In any case, the node that originates the Label Request message will also be the last hop in the ER-HOP TLV.

Once the Label Request Message has reached the last node of the persistent path, a Label Mapping Message is generated by the last node of the persistent path (in this case is also the Loop Initiator) and follows the path of the persistent path in the reversed order to complete the signaling process of the persistent path. At this stage, each node along the path of the Label Mapping Message will configure the connection entities of its connection unit and also allocate necessary network resources for the persistent path according to network constraints specified by the administrator and/or attributes carried by the Label Request/Label Mapping Message itself. When the node originating the persistent path finally receives the Label Mapping message, it creates an outgoing connection entity at the connection unit and splices the outgoing connection entity to a corresponding previously setup incoming connection entity. Hence the loop is completed. The created persistent path is identified with a Label Switch Path (LSP) ID being assigned to it.

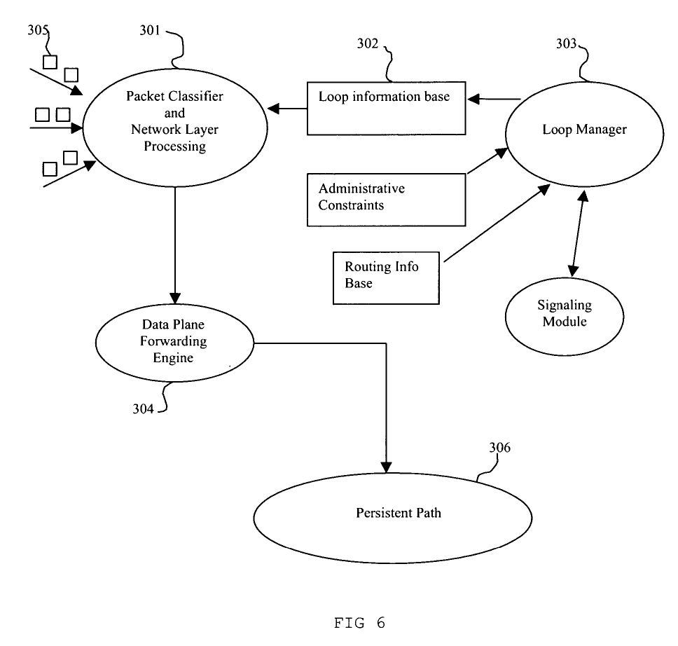

In the signaling process of creating the persistent path, an experimental TLV of the Label Request Message and/or the Label Mapping Message is used to identify the persistent path so that each DIN node along the persistent path on reading this attribute will update its persistence bit in the connection unit, such that data in this path is treated differently. The experimental TLV comprises an Unknown TLV bit, a Forward Unknown TLV bit, a Looping LSP TLV type field, a Length field and a Value field as shown in FIG. 5.

The Unknown TLV bit and the Forward Unknown TLV bit are set to “1”. According to the MPLS signaling specifications, non-DIN nodes are not able to interpret the experimental TLV and will pass the value of the experimental TLV to a next node unchanged. The DIN nodes on receiving the Label Request/Mapping Message with the Looping LSP TLV set will perform signaling protocol modifications as described below.

Modifications to Loop Detection Mechanisms in Signaling Protocol

Loops in network are generally undesirable as they use up valuable network bandwidth resources required for data transmission resulting in wastage of the bandwidth resources. Therefore, signaling protocols running in most networks have loop detection mechanisms for detecting such undesirable loops and aborting them.

Loop detection is a configurable option in the signaling protocol, such as LDP or RSVP, running in the MPLS based network. The loop detection option has to be turned “on” at all the nodes in the network in order for loop-detection mechanism to function correctly. The method according to the invention enables creation of looping paths which can be differentiated from the undesired looping paths, so that only the undesired looping paths are detected and aborted by the loop detection mechanisms.

Modifications to the signaling protocol are performed at at least one DIN node along the persistent path created according to the invention. The modifications to the signaling protocol are to prevent the loop detection mechanism of the signaling protocol from detecting the persistent path and aborting it.

Two attributes in the Label Request Message and the Label Mapping Message of the LDP signaling protocol are used for detection of looping paths in the network.

A first attribute, HOP COUNT TLV, has a value which is incremented at every node along a path in the network. When the value of the HOP COUNT TLV exceeds a certain threshold value, the path signaled by the Label Request/Mapping Message is deemed to be looping. The node which detected the exceeded HOP COUNT TLV value sends a status signal to the source of the Label Request/Mapping Message, and aborts the signaling of the path.

According to the invention, the value of the HOP COUNT TLV is reset to a value of “1” at at least one DIN node along the persistent path. In this way, the value of the HOP COUNT TLV will not exceed the threshold value, and hence the signaling of the persistent path will not be aborted by the signaling protocol.

At every node along the path signaled by the signaling protocol, identifier of each corresponding node (LSR ID) is added to a second attribute of the Label Request/Mapping Message, which is the PATH VECTOR TLV. When the PATH VECTOR TLV becomes too long and exceeds a threshold length, the path is assumed to be looping and hence, the signaling of the path is aborted.

According to the invention, all intermediate node identifiers in the PATH VECTOR TLV are removed at at least one DIN node along the persistent path, and substituted with the identifier of that DIN node. This is to prevent the PATH VECTOR TLV from becoming too long and as a result, the corresponding path being interpreted as a looping path. In addition, this also prevents other nodes from detecting their own node identifiers in the PATH VECTOR TLV, which is also an indication that the path is looping.

It should be noted that although the modification of the attributes described above relates to the LDP signaling protocol, such modifications can also be implemented in other signaling protocols like RSVP.

Specifically, a Path Message of the RSVP signaling protocol carries a LABEL-REQUEST object for creating a path in the network. An optional object, which is the RECORD_ROUTE object, in the Path Message has similar behavior as the PATH VECTOR TLV of the Label Request/Mapping Message of the LDP Signaling protocol and is used for loop detection. In the same manner, the modifications with regard to the PATH VECTOR TLV attribute can be implemented on the RECORD_ROUTE object to prevent a desired persistent path from being detected and aborted by the RSVP signaling protocol.

Management of Data in the Persistent Path

DIN nodes according to the invention classify data packets into those to be injected into the created persistent path for storage and those to be transported to one or more destination nodes in the network. Such packet classification of data can be implemented in several ways.

One embodiment of packet classification is shown in FIG. 6. An application that wants to send data packets 305 to be stored in the persistent path first sends the data packets to a Loop Controller 301 which is implemented using one DIN node. The Loop Controller 301 affixes a network or application layer header to the data packets 305, wherein the network/application layer header maps the data packets to one persistent path.

The information on the availability of the persistent path is obtained from a distributed Loop Information Base 302, which in turn obtains its information from a Loop Manager node 303. The Loop Manager 303 manages all the persistent paths in the network based on information obtained from the routing framework and other constraints imposed by administrators.

Data packets 305 having network/application-layer header field are affixed further with a MPLS header at the DIN node, wherein the MPLS header comprises an outgoing label which maps the data packet to the persistent path. The data packets 305 are subsequently forwarded to the persistent path 306 and persisted therein, as the nodes along the path perform simple forwarding based on the label on each of the data packets 305.

In another embodiment of the invention, data packets classification is based on Internet Protocol (IP) addresses. Data packets desired to be stored in a persistent path in the network are affixed with an IP address having a destination belonging to a subset of a private IP address space. This affixing of a new IP destination header is done by a DIN node.

In this case, the data packets are sent by an application/node to an appropriate DIN node having a “Write/Inject” service. The DIN node reads the header of each of the data packets, and/or other parameters sent by a requesting application/node, and affixes a new network layer header such that the packet now has a destination in the private IP address space. Each of the data packets with the affixed network layer header is then routed out through an IP interface of the DIN node, and is stored in the associated persistent path.

The IP interface which is also an outgoing interface for that data packet at the DIN node could be an MPLS tunnel interface. However, the IP interface is only the outgoing interface for the said private IP address space according to the DIN node's routing table In addition, the destination IP address is also bound to an outgoing MPLS label which is obtained based on Forwarding Equivalence Class (FEC) to Next Hop Label Forwarding Entry (NHLFE) (FTN) mapping. This mapping is created at each DIN node during the creation process of the switched path.

Thus the data packets are affixed with the outgoing label by looking up the FTN map for the DIN node. This is done by the COLL unit of the DIN node. The data packets are finally sent out via associated physical network interface into the persistent path. In this case, the DIN node functions as the ingress node.

In both of the above embodiments, the injected data packets follow the path of the persistent path and will return to the ingress node. However, now the data packets would each have an incoming label affixed to them, and the ingress node functions as a normal switching node and uses an Incoming Label Map to switch the data packets to the next hop in the persistent path. Therefore, the data packets are circulated and hence, stored in the persistent path.

In the MPLS network, MPLS data packet headers contains a Time-to-Live (TTL) field. This TTL field is always set to a maximum value at the ingress node and is decremented at every node along its path in the network. When the value of the TTL field is decremented to “0” at a node, the corresponding data packet will be discarded by that node. Hence the TTL field in the MPLS data packet header is also used as a “looping packet detection” mechanism in the network in addition to the loop detection mechanisms in the signaling framework.

In order for the data packets in the persistent path to have an indefinite life time and not be discarded, the value of the TTL field of the header of the data packets is reset to the maximum value at at least one of the DIN nodes along the persistent path.

This can be accomplished, for example, by the ingress node of the data packets in the persistent path. In this case, when the DIN ingress node generates the outgoing label to the persistent path, a “looping LSP” flag can be set in an Incoming Label Map entry (an attribute in the connection unit) for that persistent path or outgoing label. By setting this flag, the ingress node, which is path of the persistent path, will then process the forwarding header of data packets in the persistent path differently by resetting the TTL field to its maximum value.

It should be noted that the mechanism for resetting the value of the TTL field are only in relation to PSC nodes. In non-PSC nodes, there is no packet header processing and hence, TTL field are not processed. However, the system allows any specific method, such as regeneration of the input optical signal, to be applied instead. Therefore, data in the persistent path will persist until other events signal the deletion of the persistent path or its content.

The persistent paths created according to the invention have infinite lifetime, unless the path is signaled to be deleted. The content of the persistent path can be modified or cleared without having to delete the persistent path.

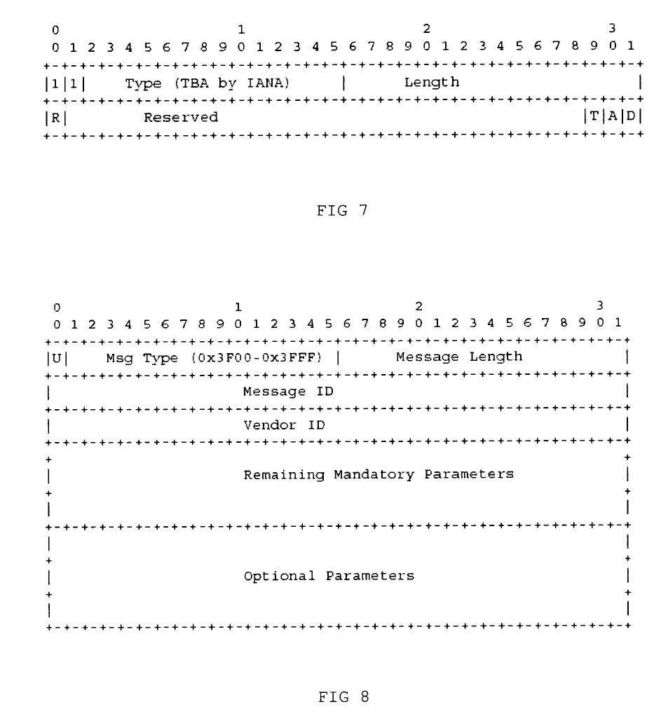

A mechanism in the generalized MPLS, called the Administrative Status Information, is used for removing the contents of the persistent path. The Administrative Status Information is carried in an Admin Status Object in the Label Request/Mapping Message as shown in FIG. 7. Therefore when the Label Request/Label Message having the Admin Status Object is received by a DIN node of the persistent path, the DIN node updates its local LSP state table (or connection unit) by setting the persistent path to be administratively “down”. As a result, any data packets arriving at that DIN node on the “downed” persistent path are dropped, until an Admin Status Object associated with the persistent path causes it to be administratively “up” again.

When an application wants to read the content of the persistent path, a DIN node duplicates the relevant content in the persistent path into a buffer, and sends the duplicated data to the application. The DIN node should also continue to forward the data packets in the persistent path so that the data packets continue to persist in the path. Thus the DIN node implements a non-destructive read feature.

The request for duplicating the content of the persistent path is triggered by a new experimental message which can be generated by a computer node running the signaling protocol. The experimental message is known as an Action Message as shown in FIG. 8. The experimental message comprises a U bit, a Msg Type, a Message Length, a Message ID, a Vendor ID, Remaining Mandatory parameters and Optional parameters.

The U bit is an Unknown message bit. Upon receipt of an unknown message, a notification is returned to the source of the experimental message if U bit is clear (“0”). If U bit is set (“1”), the unknown message is ignored. The Msg Type has a range between 0x3F00 and 0x3FFF. A Msg Type, for example 0x3F01, may be uniformly interpreted by all DIN nodes as a Action Message. The Msg Type and the Vendor ID specify how the message is to be interpreted. The Message Length specifies the cumulative length in octets of the Message ID, Vendor ID, Remaining Mandatory parameters and the Optional parameters. A LSP ID TLV is one of the remaining mandatory parameters that specifies on which switched persistent path the duplication action is to be performed.

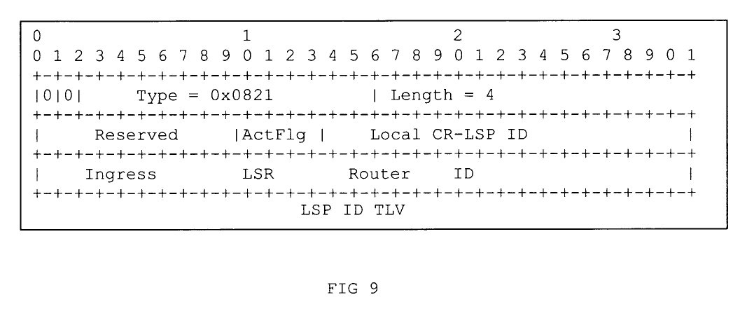

The LSP ID TLV is a mandatory parameter for the Label Request Message, and is used to uniquely identify an LSP within the generalized MPLS network. When a message to duplicate the contents of a looping LSP is received by a DIN node, the message must also have an attribute to identify the LSP whose contents have to be duplicated. In this case, the attribute for identifying the said LSP for data duplication is provided by the LSP ID TLV. The LSP ID TLV of the Action Message is shown in FIG. 9.

The Message ID is a 32-bit integer which is set to 0x0001 to identify the experimental message. The Message ID is used by the LSR to facilitate the identification of notification messages that may apply to this message. The Vendor ID is not applicable in this case. The Remaining Mandatory and Optional parameters are variable length set of remaining required message parameters and optional message parameters, respectively. This experimental Action Message is understood by all the DIN nodes.

The Action Message is sent explicitly to a target DIN node where duplication of the content of the persistent path is desired. Upon receipt of the Action Message by the target node, the target node sets a “duplicate” bit in its local LSP state table (or connection unit) for the said persistent path. As a result, every incoming data packet arriving at the target node from the persistent path is duplicated.

In addition, a forwarding action may be attached to the persistent path in the LSP state table of the target node, so that the duplicated data packets can be channeled into another path in the network to be transported to a requesting node using the normal transportation function of the computer network.

The duplicated data packets can also be delivered to the requesting node by giving them a valid network layer header. In this case, the delivery mechanism uses the same network as a transport pipe.

While the embodiments of the invention have been described, they are merely illustrative of the principles of the invention. Other embodiments and configurations may be devised without departing from the spirit of the invention and the scope of the appended claims.

The Following References are Cited in this Document:

[1] Open Shortest Path First (OSPF) Protocol—http://www.ietf.org/rfc/rfc1583.txt
[2] Intermediate System (IS-IS) Protocol—http://www.ietf.org/rfc/rfc1142.txt
[3] Label Distribution Protocol Specification—http://www.ietf.org/rfc/rfc3036.txt
[4] Extensions to RSVP for MPLS Tunnels—http://www.ietf.org/rfc/rfc3209.txt
[5] Banerjee et al, Generalized Multiprotocol Label Switching: An overview of routing and management Enhancements, IEEE Communications Magazine, January 2001.
[6] MPLS Architecture—http://www.ietf.org/rfc/rfc3031.txt
[7] CANARIE Inc., Wavelength Disk Drives, http://www.ccc.on.ca/wdd/
[8] Building Scalable Service Provider IP Networks, Marconi white paper, July 2000, http://www.marconi.com/media/scalable_wp.pdf
[9] Constrained-based LSP setup using LDP—http://www.ietf.ora/rfc/rfc3212.txt
[10] Link Management Protocol—http://www.ietf.org/internet-drafts/draft-ietf-ccamp-lmp-04.txt
[11] Requirements for Traffic Engineering over MPLS—http://www.ietf.org/rfc/rfc2702.txt
[12] Traffic-engineering extensions to OSPF—http://www.ietf.org/internet-drafts/draft-katz-yeung-ospf-traffic-06.txt

1. A method for enabling storage of data in a computer network comprising a plurality of computer nodes, wherein each computer node comprises at least one connection oriented link layer unit, the method comprising the steps of:
defining a looping path in the computer network, wherein the looping path comprises a plurality of computer nodes and connections between the computer nodes; and
configuring a connection unit at each node along the looping path, the connection unit being supported by the connection oriented link layer unit,
such that the connection oriented link layer unit at each computer node is able to send incoming data which is to be stored in the computer network to a next computer node along the looping path based on the connection unit, thereby providing the looping path for data to be circulated therein, and thereby enabling the storage of data in the computer network.

2. The method for enabling the storage of data in a computer network according to claim 1, wherein the connection oriented link layer unit is implemented according to a generalized Multi-protocol Label Switching specification.

3. The method for enabling the storage of data in a computer network according to claim 1, wherein a signaling framework is supported by the connection oriented link layer unit at each computer node and is implemented by a signaling protocol running on the nodes.

4. The method for enabling the storage of data in a computer network according to claim 3, wherein the connection unit at each computer node of the computer network is configured by a signaling message generated by the signaling protocol running on the computer nodes of the computer network.

5. The method for enabling the storage of data in a computer network according to claim 1, further comprising the step of setting an attribute of the connection unit at each computer node of the looping path, wherein the attribute of the connection unit is used to identify the created path as a looping path for storing data.

6. The method for enabling the storage of data in a computer network according to claim 5, wherein the attribute of the connection unit at each computer node of the looping path is set by a signaling message generated by a signaling protocol running on the computer nodes of the computer network.

7. The method for enabling the storage of data in a computer network according to claim 6, further comprising steps of
identifying the looping path in the computer network by determining whether an attribute of the signaling message is set; and
preventing the identified looping path from being aborted by the signaling protocol running on the computer nodes of the computer network when the attribute of the signaling message is set to the predefined value.

8. The method for enabling the storage of data in a computer network according to claim 7, wherein a further attribute of the signaling message having a value which is being incremented at each computer node along the looping path is set to a predefined value at at least a predefined computer node of the looping path.

9. The method for enabling the storage of data in a computer network according to claim 7, wherein a further attribute of the signaling message having a node identifier of each computer node being added to it at the respective computer node of the looping path is set to a predefined value at at least a predefined node of the looping path.

10. A method for storing data in a computer network comprising a plurality of nodes, wherein each node comprises at least one connection oriented link layer unit, the method comprising the steps of
identifying a looping path in the computer network comprising a plurality of computer nodes defined by the connection oriented link layer unit of a computer node; and
injecting data into the identified looping path at the computer node, in which looping path the injected data is to be circulated in, thereby storing the data in the computer network.

11. The method for storing data in a computer network according to claim 10, wherein the connection oriented link layer unit is implemented according to a generalized Multi-protocol Label Switching specification.

12. The method for storing data in a computer network according to claim 10, further comprising the steps of
affixing a header to each data packet of the data to be injected into the identified looping path at the node, wherein the header is associated with the identified looping path;
determining a forwarding path information of the header affixed to the data packet by the connection oriented link layer unit at the computer node; and
affixing further a connection oriented link layer header to the data packet affixed with the header by the connection oriented link layer unit at the computer node, wherein the connection oriented link layer header comprises an outgoing label which maps the data packet into the identified looping path, thereby storing the data in the computer network.

13. The method for storing data in a computer network according to claim 12, wherein a time to live field of the connection oriented link layer header having a value which is being decremented at each computer node is set to a predefined value by the unit at at least one computer node along the identified looping path.

14. The method for storing data in a computer network according to claim 10, wherein data stored in the looping path of the computer network is removed by
setting an administrative bit in a signaling message generated by a signaling protocol running on the computer nodes of the computer network to a predefined value; and
sending the signaling message to a computer node along the looping path, thereby setting an administrative attribute of a connection unit at the computer node and causing the computer node to remove the data stored in the looping path of the computer network.

15. The method for storing data in a computer network according to claim 10, wherein data stored in the looping path of the computer network is read by
sending an experimental message generated by a signaling protocol running on the computer nodes of the computer network to a computer node along the looping path, thereby setting a duplicate attribute of a connection unit at the computer node and causing the computer node to duplicate the data stored in the looping path of the computer network.

16. A system for enabling storage of data in a computer network comprising a plurality of computer nodes, wherein each computer node comprises at least one connection oriented link layer unit, the system comprising the steps of:
a definition unit for defining a looping path in the computer network, wherein the looping p comprises a plurality of computer nodes and connections between the computer nodes; and
a configuration unit for configuring a connection unit at each node along the looping path, the connection unit being supported by the connection oriented link layer unit;
such that the connection oriented link layer unit at each computer node is able to send incoming data which is to be stored in the computer network to a next computer node along the looping path based on the connection unit, thereby providing the looping path for data to be circulated therein, and thereby enabling the storage of data in the computer network.

17. The system for enabling storage of data in a computer network according to claim 16, wherein the connections between computer nodes are optical fibers.

18. A system for storing of data in a computer network comprising a plurality of computer nodes, wherein each computer node comprises at least one connection oriented link layer unit, the system comprises
an identification unit for identifying a looping path in the computer network comprising a plurality of computer nodes by the connection oriented link layer unit of a computer node; and
an injection unit for injecting data into the identified looping path at the computer node, in which looping path the injected data is to be circulated in, thereby storing the data in the computer network.

19. A system for storing of data in a computer network according to claim 18, each computer node further comprises a removal unit for removing the injected data in the looping path when an administrative attribute of a connection unit is set, thereby causing the computer node to remove the data stored in the looping path of the computer network.

20. A system for storing of data in a computer network according to claim 18, each computer node further comprises a retrieval unit for duplicating the injected data in the looping path when a duplicate attribute of a connection unit is set, thereby causing the computer node to retrieve the data stored in the looping path of the computer network.
